(19) United States
(12) Patent Application Publication
(10) Pub. No.: US 2017/0114926 A1
(43) Pub. Date: Apr. 27, 2017

(54) VALVE POSITION INDICATION DEVICES AND USES

(71) Applicant: TOPCO OILSITE PRODUCTS LTD., Calgary (CA)

(72) Inventors: DAVID BRADLEY SOLOWAY, Red Deer (CA); TOM LANGLEY, Medicine Hat (CA); CHRIS HERMAN, Calgary (CA); JASON HUEHN, Calgary (CA)

(21) Appl. No.: 15/244,925

(22) Filed: Aug. 23, 2016

Related U.S. Application Data
(60) Provisional application No. 62/244,426, filed on Oct. 21, 2015.

(51) Int. Cl. F16K 37/00

(52) U.S. Cl. CPC F16K 37/0058

(57) ABSTRACT

Valve position indication devices for monitoring valve position. The invention also encompasses uses and applications for such devices. The indication devices may be intended for use in a variety of industries, including the petroleum industry. The indication device is adapted such that it can be visually distinct when viewed in alternate valve positions.

### FIELD OF THE INVENTION

The invention disclosed herein is generally related to valve position indication devices for monitoring the position of a valve. Such devices may be intended for use in a variety of industries, such as the petroleum industry.

### BACKGROUND OF THE INVENTION

One long standing problem in the field in oil and gas operations is in the determination of the operational status or position of a valve, including whether the valve is open or closed. This can be of particular importance when dealing with flows under considerable pressures such as, for example, in hydraulic fracturing operations.

The conventional practice in the field may require the physical inspection of each valve by an operator. This can require the operator to personally visit the physical location of each valve and inspect the position of the valves. This practice may be further complicated in low light, obscured or night time operations whereby an operator may be required to be even closer to the valve and may further require a need to bring an illumination source to ascertain the valve position in particular situations.

It would be advantageous for there to be a means that could save operator time and/or improve operator accuracy in assessment of valve position and/or reduce the likelihood of costly errors being made in the field.

It would therefore be advantageous for there to be a means for permitting an operator to monitor the position of a valve without one or more of the problems identified above.

### SUMMARY OF THE INVENTION

The invention disclosed herein is generally related to valve position indication devices for monitoring the position of a valve.

In accordance with an embodiment, the invention is directed to a valve position indication device for monitoring valve position comprising first and second substantially flat side surfaces, the side surfaces parallel to one another; first and second parallel end surfaces, the end surfaces substantially narrower that the side surfaces; a top surface; a mounting surface parallel to the top surface, the mounting surface adapted for engagement with a valve or a valve actuator; and wherein a first position of the device indicates a first valve position and a second position of the device indicates a second valve position.

In accordance with another embodiment, the invention is directed to a valve position indication device comprising an indicating means for providing a visual determination of an operational position of a valve, the indicating means comprising a first and a second substantially flat side surface, a first and a second end surface substantially narrower than the first and the second side surface, a top surface, and a lower surface parallel to the top surface; and an adapter means, detachably disposed under the indicating means, the adapter means having an upper surface and a lower surface, the upper surface of the adapter means adapted for engagement with the lower surface of the indicating means and the lower surface of the adapter means adapted for engagement with a specific valve or valve actuator design; and wherein a first position of the device indicates a first valve position and a second position of the device indicates a second valve position.

In accordance with another aspect, the invention is directed to an indicating means for providing a visual determination of an operational position of the valve comprising: a first and a second substantially flat side surface; a first and a second end surface substantially narrower that the first and the second side surface; a top surface; and a lower surface parallel to the top surface, adapted for engagement with an adapter means.

In accordance with a further aspect, the invention is directed to an adapter comprising an upper surface adapted for engagement with an indicating means; and a lower surface adapted for engagement with a specific valve or valve actuator design.

In accordance with another aspect, the invention is further directed to particular uses of the indication devices. Such devices may be intended for use in a variety of industries, such as in the petroleum industry.

Further aspects, features and advantages of the present invention will be apparent from the following descriptions.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and accompanying drawings in which:

FIG. 1 is a side perspective view of one embodiment of a valve position indication device in accordance with the present invention;

FIG. 2 is a top perspective view of the indication device shown in FIG. 1;

FIG. 3 is an end perspective view of the indication device shown in FIG. 1;

FIG. 4 is a top perspective view of an example of a hydraulic valve actuator with a groove machined thereon;

FIG. 5 is a bottom perspective view of one embodiment of a valve position indication device;

FIG. 6 is a bottom perspective view of an alternate embodiment of a valve position indication device;

FIG. 7 is a side perspective view of an alternate embodiment of a valve position indication device that includes an insert;

FIG. 8 is a side perspective view of the indication device shown in FIG. 7, with an insert disposed within;

FIG. 9 is a bottom perspective view of the indicating means shown in FIG. 7;

FIG. 10 is a top perspective view of an insert of the present invention;

FIG. 11 is a bottom perspective view of an embodiment of an insert of the present invention;

FIG. 12 is a bottom perspective view of an alternative embodiment of an insert of the present invention;

FIG. 13 is a side perspective view of a valve position indication device with an alternate embodiment of an insert;

FIG. 14 is a perspective view of the insert of FIG. 13;

FIG. 15 is a bottom view of the insert of FIG. 13;

FIG. 16 is a side perspective view of a valve position indication device with an alternate embodiment of an insert;

FIG. 17 is a perspective view of the insert of FIG. 16;

FIG. 18 is a bottom view of the insert of FIG. 16;

FIG. 19 is a side perspective view of a valve position indication device with an alternate embodiment of an insert;

FIG. 20 is a perspective view of the insert of FIG. 19;

FIG. 21 is a bottom view of the insert of FIG. 19;

FIG. 22 is a side perspective view of a valve position indication device with an alternate embodiment of an insert;

FIG. 23 is a perspective view of the insert of FIG. 22;

FIG. 24 is a bottom view of the insert of FIG. 22;

FIG. 25 is a side perspective view of a valve position indication device with an alternate embodiment of an insert;

FIG. 26 is a perspective view of the insert of FIG. 25;

FIG. 27 is a bottom view of the insert of FIG. 25; and

FIG. 28 is a side perspective view of a valve position indicator device further comprising reflectors.

### DESCRIPTION OF THE PREFERRED EMBODIMENT

The present invention relates to particular valve position indication devices as well as for uses of such devices. When describing the present invention, any term or expression not expressly defined herein shall have its commonly accepted definition understood by those skilled in the art. To the extent that the following description is of a specific embodiment or a particular use of the invention, it is intended to be illustrative only, and not limiting of the invention, which should be given the broadest interpretation consistent with the description as a whole.

The invention disclosed herein is generally related to valve position indication devices for monitoring the positional status of one or more valves and to particular uses for such devices. Such devices may be intended for use in a variety of industries, including the petroleum industry.

In particular, the present invention comprises a device operable for permitting an operator to visually inspect the position of a valve from a distance.

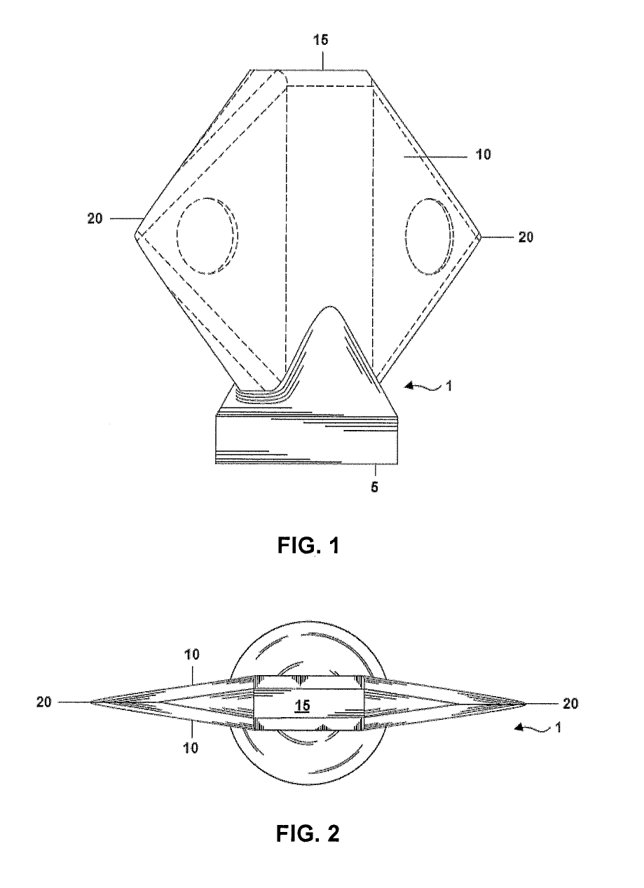

FIGS. 1-3 illustrate a valve position indication device 1 in accordance with an embodiment of the present invention. As illustrated in FIGS. 1-3, an indication device of the present invention may comprise a body shape configured so as to allow it to be visible to an operator at a given distance. The indication device of the present invention can further comprise a mounting surface 5 adapted for physically engaging the device 1 to a valve or valve actuator.

In accordance with an embodiment of the present invention, the indication device may be of sufficient size so as to be visually perceived at some distance. The indication device can turn with the position of the valve. As a result, the indication device may be in one position when the valve is open and may be in a distinctly different position when the valve is closed.

The indication device can also be adapted so as to be visually distinct in accordance with the positioning of a valve. For example, the indication device may be visible and distinct in one valve position, such as in a valve open position, and may be of limited visibility in another valve position, such as in a valve closed position.

As depicted in FIGS. 1-3, the indication device can comprise visually distinctive substantially flat side surfaces 10 and substantially less distinctive narrow end surfaces 20. The substantially flat side surfaces 10 of an indication device may be visible in accordance with a particular position of the valve, such as in either an open or a closed position.

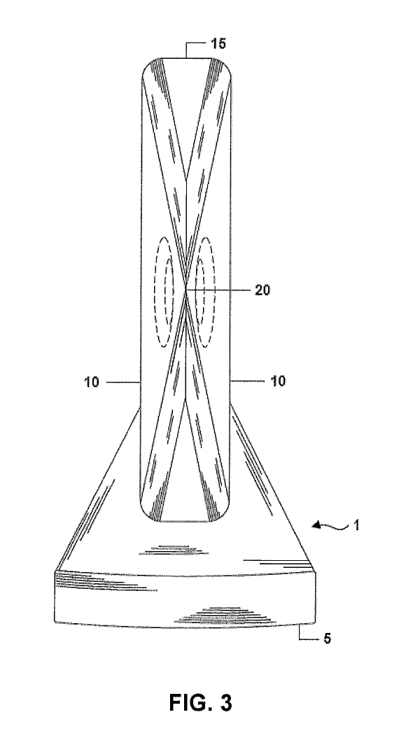

Referring now to FIG. 3, a narrow end surface 20 of the indication device can be seen. As depicted, the narrow end of the indication device may be of limited visibility when the valve is positioned in an alternate position.

In accordance with further embodiments of the present invention, the indication device can comprise any suitable geometrical shape such as, for example, a substantially square, rectangular, circular, hexagonal, pentagonal, octagonal, triangular, heptagonal, nonagonal, decagonal, etc. In accordance with further embodiments, distinctive colors may be used for indicating particular valve positions. For example, the color red may indicate a valve in a closed position, while the color green may indicate that the valve is open.

In accordance with alternate embodiments of the present invention, the indication device can further comprise any suitable color, fluorescent coating and/or reflective surface so as to make the device visible to an operator at certain distances and/or in conditions of low light, night time and obscured visibility. FIG. 28 depicts an embodiment of a valve position indication device that further comprises reflectors 150 on its surface.

Referring back to FIGS. 1-3, the valve position indication device of the present invention can comprise a lower or mounting surface 5 configured for engagement of the indication device 1 with a valve or valve actuator. The mounting surface 5 can allow for physical engagement of the indication device 1 with the valve or valve actuator.

In further embodiments, the valve position indication device of the present invention can further comprise a connector means. The connector means may be situated above the mounting surface and below the side surfaces and end surfaces and may be operable for raising the indication device above a valve. The connector means may comprise any configuration or length sufficient for raising the indication device such that it may be visible at a given distance. In applications in the petroleum industry, for example, the connector means may comprise a length or configuration so as to raise the indication device above pipe work and/or other obstructions.

In accordance with additional embodiments of the present invention, the valve position indication device of the present invention may be further configured for assisting in the installation or engagement of the indication device with a valve or valve actuator.

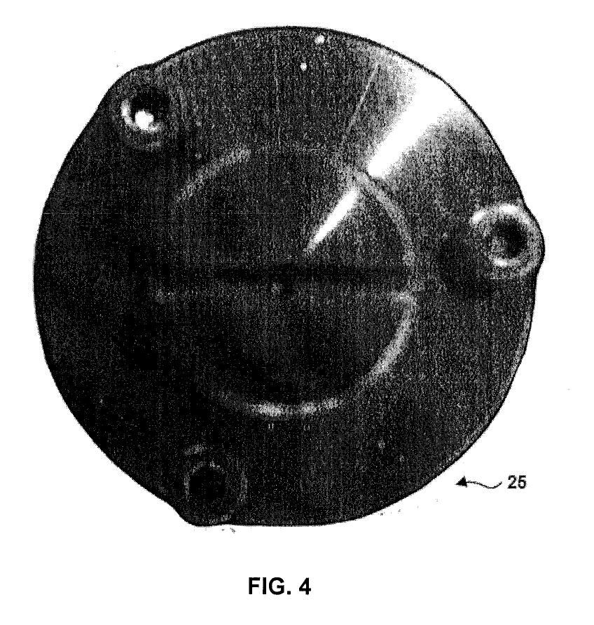

Particular hydraulic valve actuators can have grooves machined onto their tops for indicating the positioning of a valve, such as a valve open or closed position. Referring now to FIG. 4, depicted therein is an example of a hydraulic valve actuator 25 known in the art, with a groove machined thereon. In a particular embodiment, the valve position indication device of the present invention may be further configured with an extruded groove or functionally similar adaptation, which may assist in the installation and/or line up of the indication device with an actuator having a machined groove. In practice, the indication device may be installed in the exact position as the actuator itself. FIG. 5 depicts one embodiment of the mounting surface 5 of a valve position indication device comprising an extruded groove 9 configured for engagement with a round shaft. During installation onto actuator shafts having such grooves, the indication device may slide directly over the top of the shaft. Once the device is set into the actuator groove, an operator may tighten, for example, with set screws. In a particular embodiment, the valve monitoring device may be tightened. The set screws may also be embedded for ease of installation and removal.

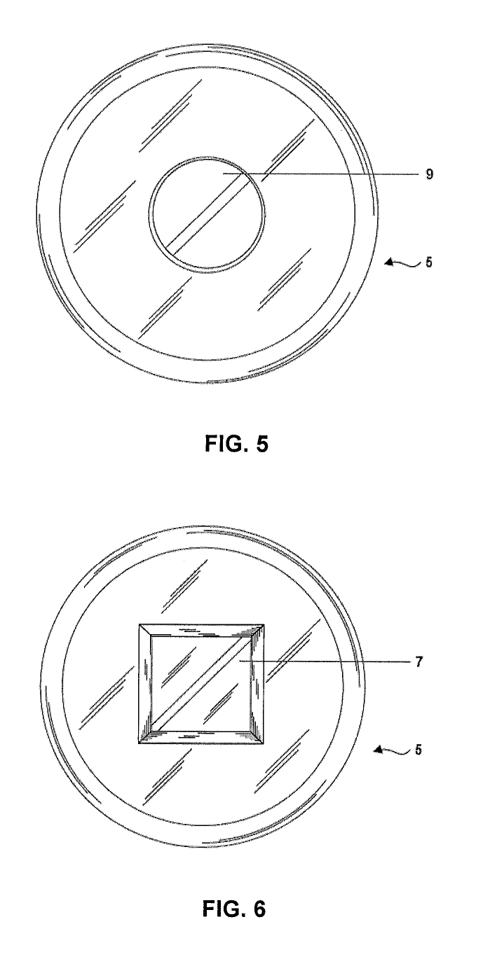

The valve position indication device may be adapted to accommodate different configurations of valve or valve actuator shafts. FIG. 6 depicts an alternative embodiment of a valve position indication device configured for engagement with a square shaft. In further embodiments the device may be adapted for accommodating a rotating plate rather than a shaft.

In accordance with alternative embodiments of the present invention, the valve position indication device may be further configured with external grooves for assisting in installation and line up with a valve or valve actuator. In an embodiment, the grooves may be etched into the outside of the indication device, in-line with the extruded groove but on the outside of the device. Such a configuration can provide added security for actuator shafts with an external groove or for installation onto actuator shafts without such a groove. The external grooves of the valve monitoring device can allow for the line up of the valve position indication device with the valve actuator. In application, a valve actuator may initially be fully opened and properly adjusted. Once completed, an operator may mark and square the direction of flow. The operator may then install the indication device, lining up the line marked on the actuator with the two external grooves on the device.

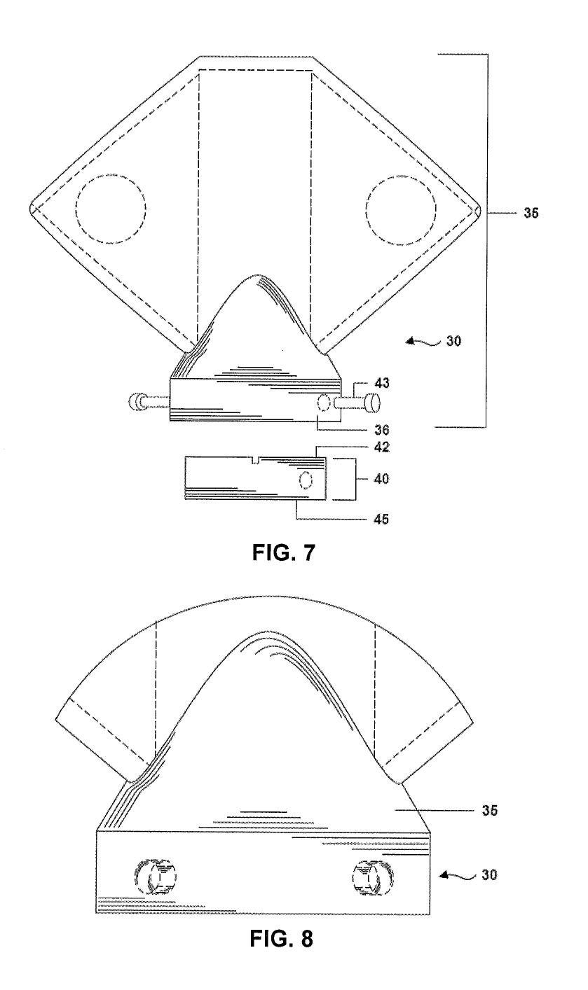

In an alternate embodiment, the valve position indicator device may be further adapted so as to accommodate a separate adapter or insert means. An insert means 40 can be configured specifically for engagement with a particular type of valve or valve actuator. Referring to FIGS. 7-8, a valve position indicator device 30 is shown comprising an indicating means 35 and an insert means 40. Engagement of the insert means 40 and the indicating means 35 is at the lower surface of the indicating means 36 and the upper surface of the insert means 42. In accordance with an embodiment, the insert means 40 may be disposed within the indicating means 35 and may be secured, for example, by one or more set screws 43. Such an embodiment can allow the indicating means 35 of the device to comprise a standard configuration with only the insert means being uniquely configured based upon application.

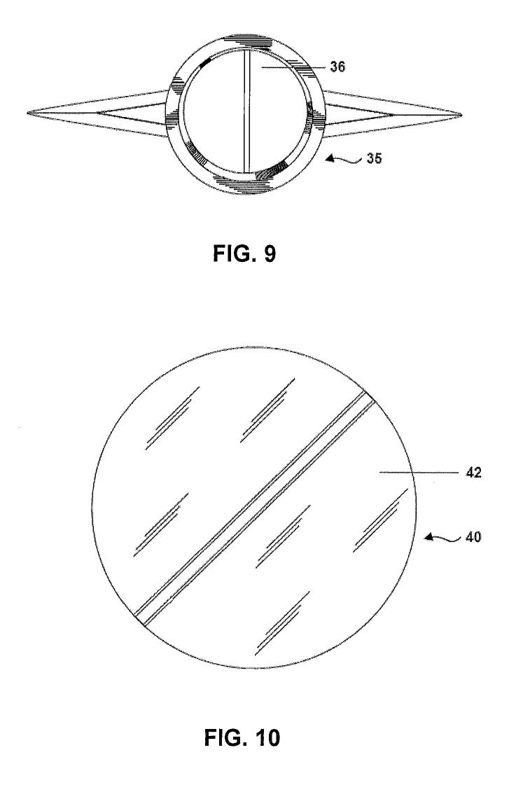

Referring now to FIG. 7 specifically, an indication device 30 is depicted prior to engagement of the indicating means 35 with the insert means 40. FIG. 8 depicts the indicating means 35 once engaged with the insert means. The upper surface of the insert means 42 can be configured for engagement with the corresponding lower surface of the indicating means 36. As depicted in FIG. 9, the lower surface of the indicating means 36 may be grooved, which may line up and engage a corresponding slot on the upper surface of the insert means 42, as depicted in FIG. 10.

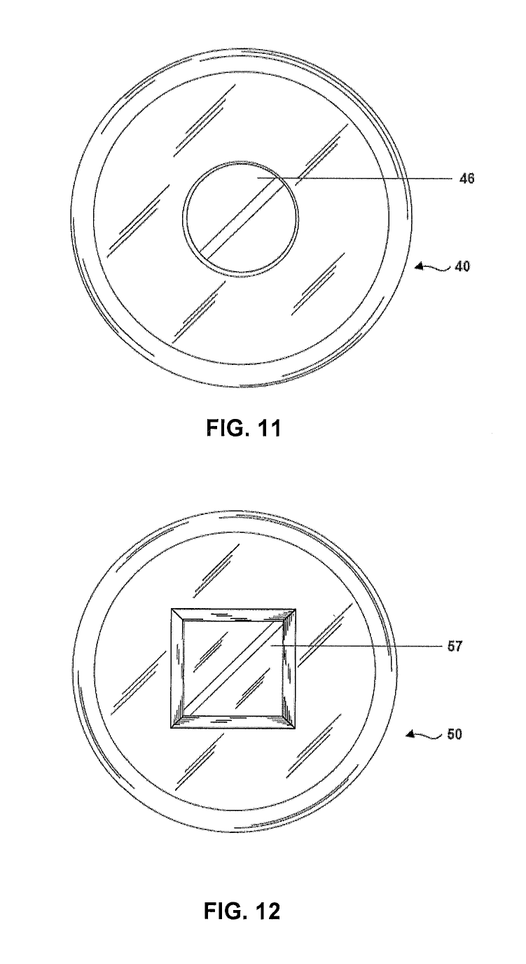

FIGS. 11-12 depict alternate embodiments of the insert means in which the lower surfaces 45, 55 of the insert means have different configurations. FIG. 11 specifically depicts an insert means 40 comprising a lower surface 46 configured for engaging a round valve or valve actuator shaft. In one embodiment, the insert means is configured for engagement with a round shaft 2″3″ hydraulic actuator. FIG. 12 depicts an alternative embodiment of an insert means 50 comprising a lower surface 57 configured for engagement with a square valve or valve actuator shaft. In one embodiment, the insert means is configured for engagement with a square shaft 1×2″ hydraulic actuator.

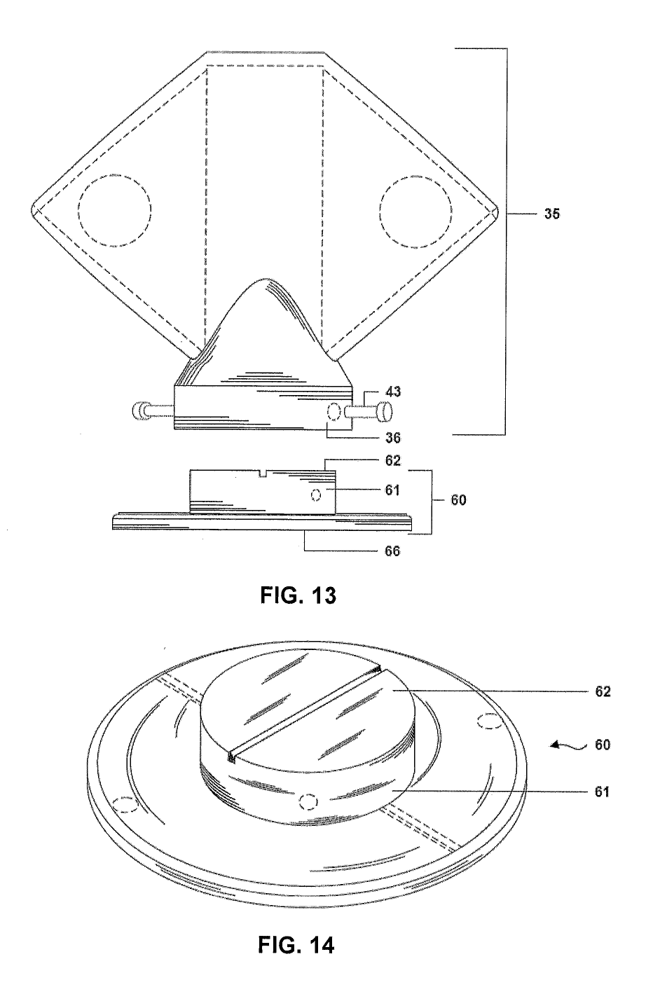

Referring now to FIGS. 13-15, a valve position indication device comprising indicating means 35 and an alternate embodiment of an insert means 60 is shown. As depicted, the insert means 60 can comprise a raised upper section 61. The insert means 60 can engage the indicating means 35 at the lower surface of the indicating means 36 and at the upper surface 62 of the raised upper section of the insert means 60. Once engaged, the raised upper section 61 may be disposed within the indicating means 35 and may be secured, for example, by one or more set screws 43.

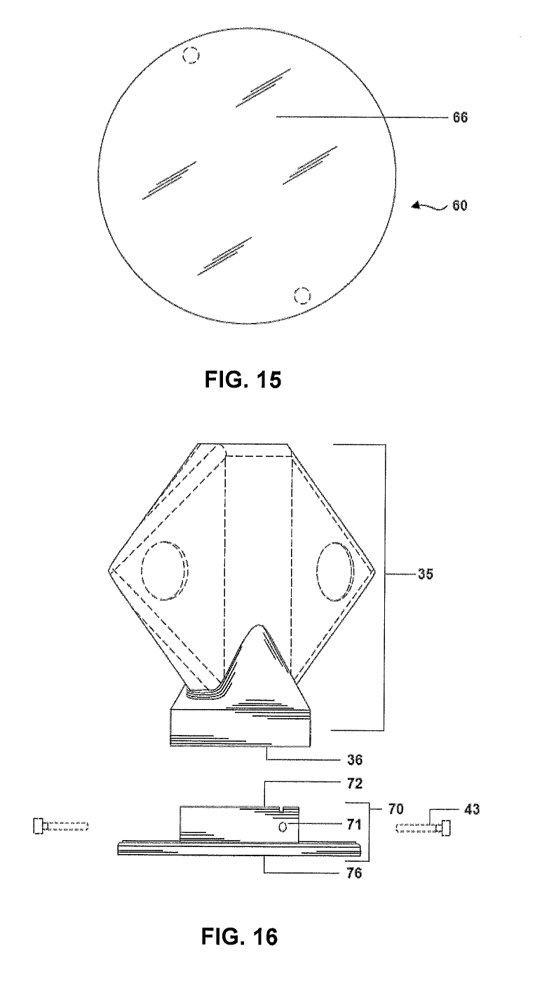

Referring to FIG. 13 specifically, an indication device is depicted prior to engagement of the indicating means 35 and the insert means 60. The upper surface 62 of the raised upper section of the insert means 62 can be configured for engagement with the corresponding lower surface of the indicating means 36. As depicted in FIG. 9, the lower surface of the indicating means 36 may be grooved, which can line up and engage with the corresponding slot on the upper surface 62 of the insert means 60, as depicted in FIG. 14. FIG. 15 depicts a bottom view of the insert means 60 comprising a lower surface 66 configured for engagement with a valve or valve actuator shaft. In one embodiment, the insert means can be adapted for engagement with a plate manual wheel operator.

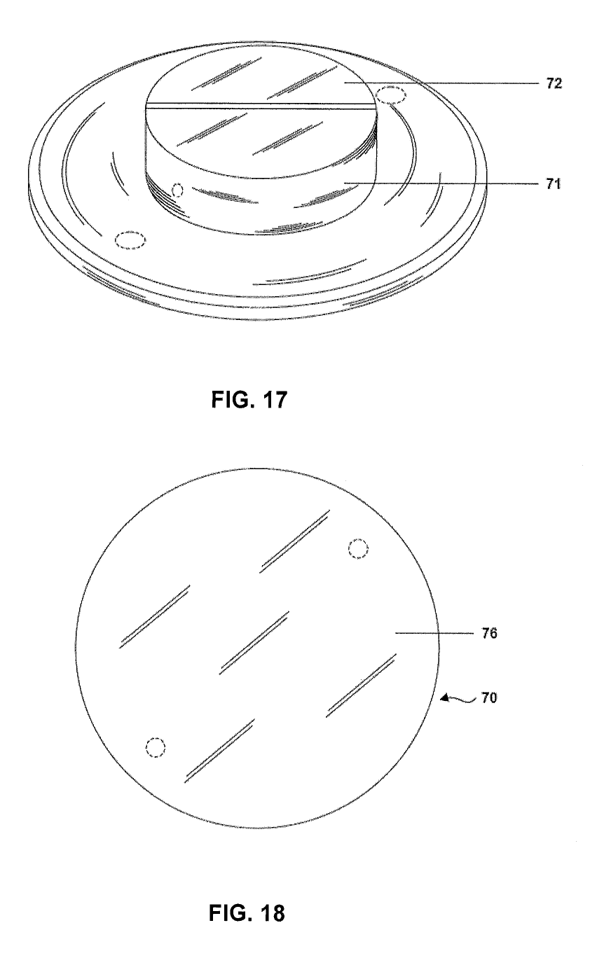

FIGS. 16-18 depict a valve position indication device comprising indicating means 35 and an alternate embodiment of an insert means 70. In accordance with the embodiment, the insert means 70 can comprise a raised upper section 71 and can engage the lower surface of the indicating means 36 at the upper surface 72 of the raised upper section 71. In accordance with an embodiment, the raised upper section 71 may be disposed within the indicating means 35 when engaged and may be secured, for example, by one or more set screws 43.

FIG. 18 depicts a bottom view of the insert means 70 comprising a lower surface 66 configured for engagement with a valve or valve actuator shaft. The insert means can be adapted for engagement with a plate manual wheel operator (flow valve version), for example.

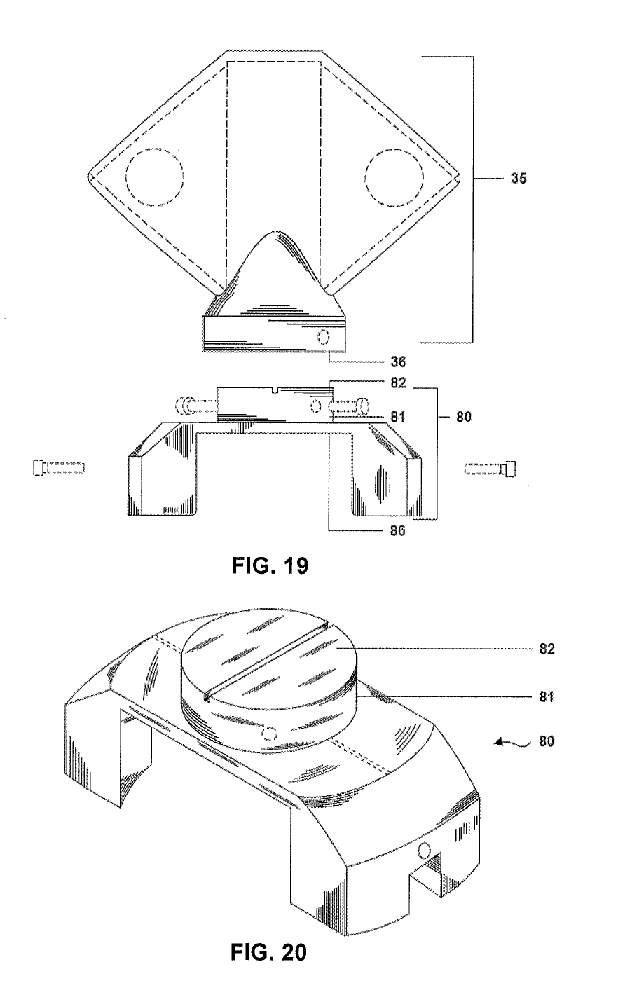

Referring now to FIGS. 19-21, a valve position indication device comprising indicating means 35 and a further embodiment of an insert means 80 is depicted. In accordance with the embodiment, the insert means 80 can comprise a raised upper section 81. Engagement is at the lower surface of the indicating means 36 and the upper surface 82 of the raised upper section 81 of the insert means 80. In accordance with an embodiment, the raised upper section 81 can be disposed within the indicating means 35 and may be secured, for example, by one or more set screws 43.

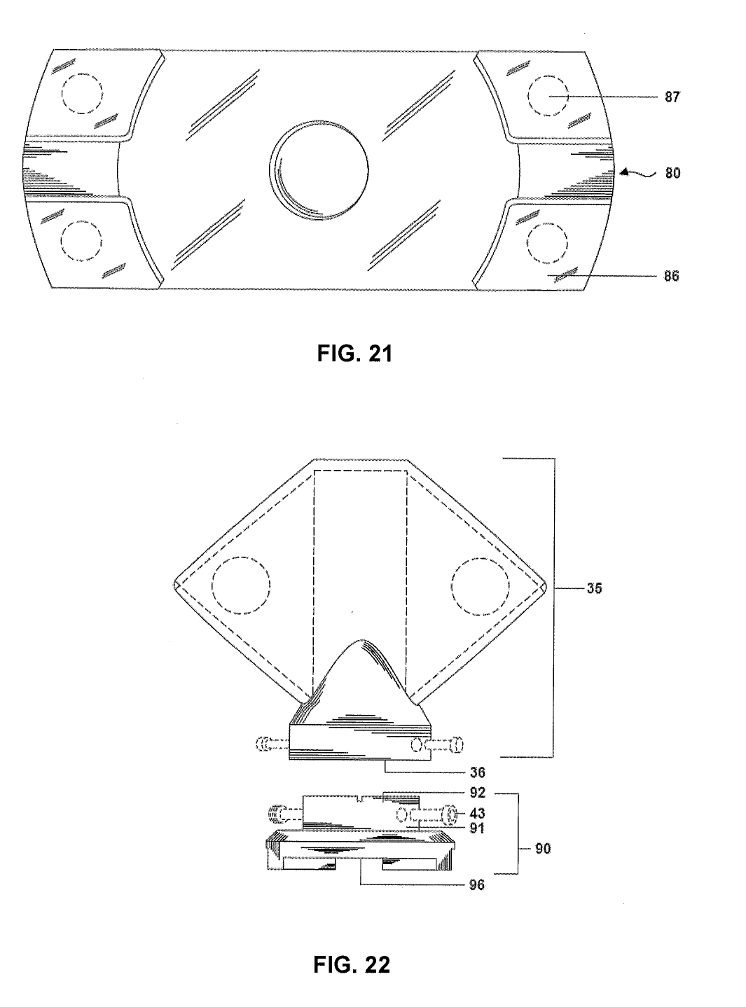

FIG. 21 depicts a bottom view of the insert means 80 comprising a lower surface 86 configured for engagement with a valve or valve actuator shaft. In an embodiment, the insert means can be adapted for use with bar operated plug valves, such as a 3″ plug valve, for example. The embodiment can further include magnets 87, which can assist in greasing the valve, etc.

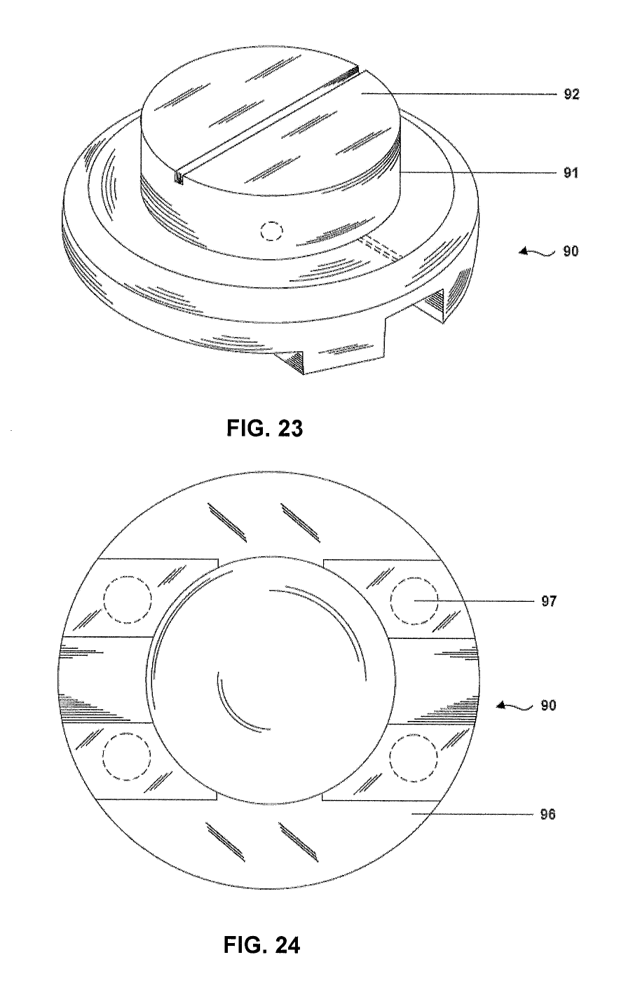

FIGS. 22-24 depict an alternate valve position indication device comprising an alternate embodiment of an insert means 90. The insert means 90 can comprise a raised upper section 91. The raised upper section 91 may be disposed within the indicating means 35 when engaged with the indicating means 35 and may be secured, for example, by one or more set screws 43. FIG. 24 depicts a bottom view of the insert means 90 comprising a lower surface 96 configured for engagement with a valve or valve actuator shaft. In an embodiment, the insert means can be adapted for use with a bar operated plug valve, such as a 1×2″ plug valve, for example. The depicted embodiment can further comprise magnets 107, for ease in greasing valves, etc.

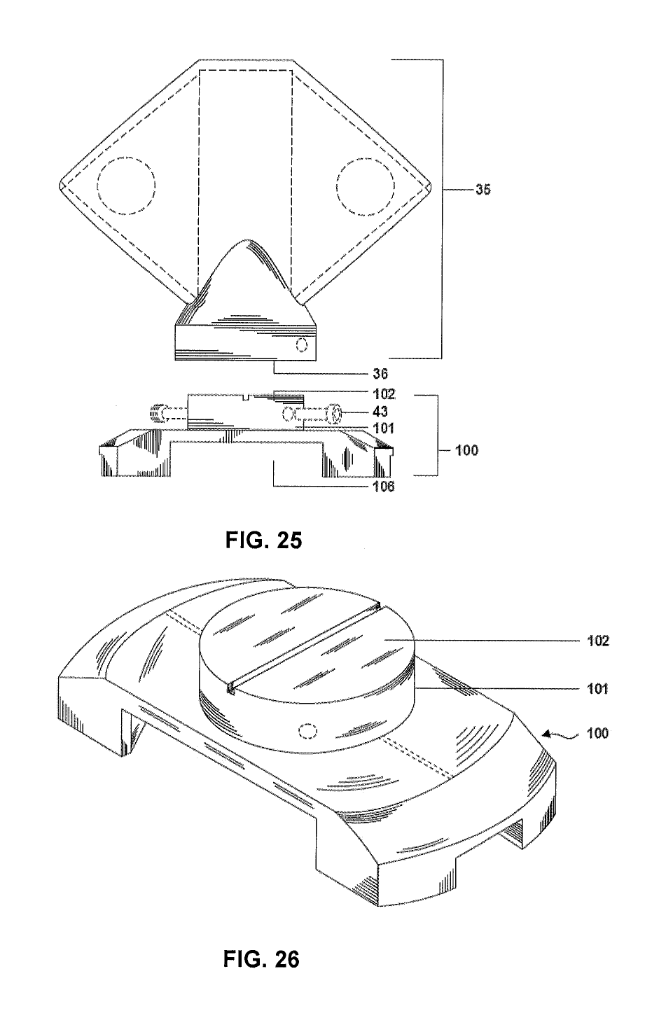

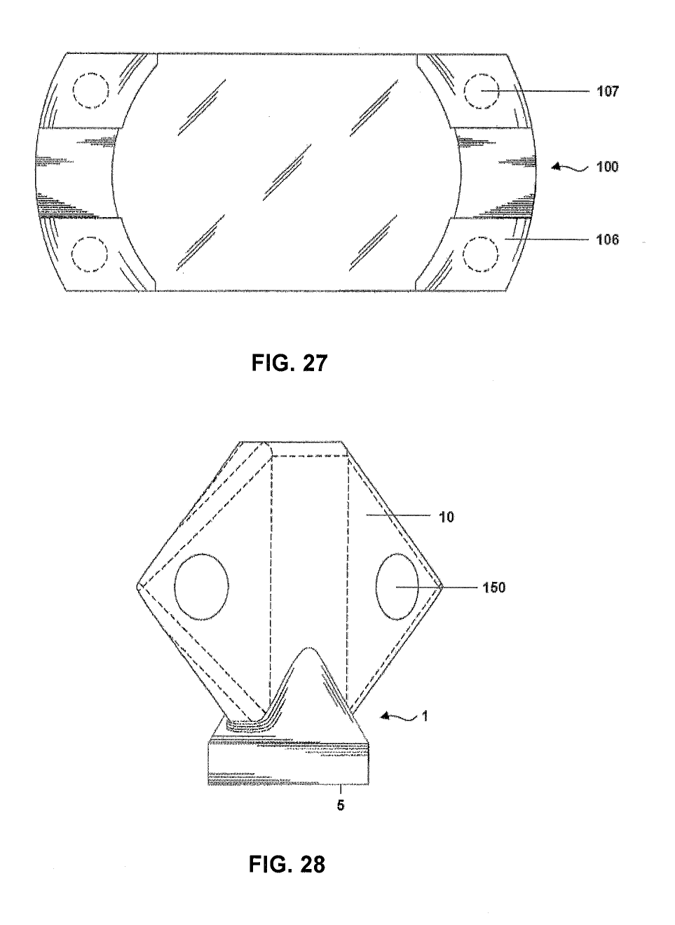

FIGS. 25-27 depict an alternate valve position indication device that comprises an alternate embodiment of an insert means 100. In accordance with the embodiment, the insert means 100 can comprise a raised upper section 101. The insert means 100 can engage the indicating means 35 at the lower surface of the indicating means 36 and at the upper surface 102 of the raised upper section 101 of the insert means 100. Once engaged, the raised upper section 101 may be disposed within the indicating means 35 and may be secured, for example, by one or more set screws 43. FIG. 27 depicts a bottom view of the insert means 100 comprising a lower surface 106 configured for engagement with a valve or valve actuator shaft. In an embodiment, the insert means can be adapted for use with a bar operated plug valve, such as a 2″ plug valve, for example. In an embodiment, the device can further comprise magnets 107, for ease in greasing valves, etc.

The composition of the valve position indication device itself may comprise any rigid material or mixtures thereof, with any preferences to materials used directed to durability in harsh service environments which can include extreme temperatures and corrosive chemicals. In an embodiment, the valve monitoring device may comprise a polymer or combination of polymers. In an embodiment, the device can comprise urethane or can comprise a thermosetting polymer, such as polyurethane. Other materials may include metals, carbon fiber, polymeric materials or composites, or any other suitable structural material or any combination thereof.

In further aspects, the valve position indication device may further comprise electronics which may be operable for allowing the valve position to be identified remotely by an operator, and out of the line of sight, by wired or wireless means.

Use of the valve position indication device of the present invention can encompass applications in a variety of different industries, including the oil and gas industry.

In one aspect, the indication devices may be used in conjunction with valves used in the pressure pumping field. In a further aspect, the valve position indication devices may be used in conjunction with high pressure equipment, such as, for example, on high pressure plug valves rated from 10,000 PSI to 20,000 PSI. In another aspect, the devices may be used in conjunction with quarter turn high pressure plug valves, or hydraulic and manual actuators that are fitted for high pressure plug valves.

The above-described embodiments of the invention are intended to be examples only. Alterations, modifications and variations can be effected to the particular embodiments by those of skill in the art without departing from the scope of the invention.

What is claimed is:

1. A valve position indication device for monitoring valve position comprising:
first and second substantially flat side surfaces, the side surfaces parallel to one another;
first and second parallel end surfaces, the end surfaces substantially narrower that the side surfaces;
a top surface;
a mounting surface parallel to the top surface, the mounting surface adapted for engagement with a valve or a valve actuator; and
wherein a first position of the device indicates a first valve position and a second position of the device indicates a second valve position.

2. The device of claim 1, wherein the first or the second side surface is visible in the first valve position, and the first and the second side surface is substantially less visible in the second valve position.

3. The device of claim 2, wherein the first valve position and the second valve position indicates either an open or a closed position of the valve.

4. The device of claim 2, wherein geometric shape of the device is substantially square, rectangular, circular, hexagonal, pentagonal, octagonal, triangular, heptagonal, nonagonal, or decagonal.

5. The device of claim 2, wherein the first and second side surfaces have a different color than the first and second end surfaces.

6. The device of claim 2, wherein the first or second side surface further comprises one or more of fluorescent coating, reflective coating, reflectors, distinctive color, or reflective means.

7. The device of claim 2, wherein the first or second side surface is visible in an open valve position and the first or second side surface is substantially less visible in a closed valve position.

8. The device of claim 1, wherein the mounting surface further comprises a groove, adapted for engagement with an actuator shaft.

9. The device of claim 1, wherein the mounting surface is adapted to accommodate engagement with a square shaft, a round shaft, a bar operated plug valve or a plate manual wheel operator.

10. A valve position indication device comprising:
An indicating means for providing a visual determination of an operational position of a valve, the indicating means comprising a first and a second substantially flat side surface, a first and a second end surface substantially narrower than the first and the second side surface, a top surface, and a lower surface parallel to the top surface; and
an adapter means, detachably disposed under the indicating means, the adapter means having an upper surface and a lower surface, the upper surface of the adapter means adapted for engagement with the lower surface of the indicating means and the lower surface of the adapter means adapted for engagement with a specific valve or valve actuator design; and
wherein a first position of the device indicates a first valve position and a second position of the device indicates a second valve position.

11. The device of claim 10, wherein the first or the second side surface of the indicating means is visible in the first valve position, and the first and the second side surface is substantially less visible in the second valve position.

12. The device of claim 11, wherein the first valve position and the second valve position indicates either an open or a closed position of the valve.

13. The device of claim 11, wherein the lower surface of the indicating means comprises a groove and the upper surface of the adapter means comprises a slot, the groove configured for engagement with the slot.

14. The device of claim 10, wherein the lower surface of the adapter means is adapted for engagement with a round shaft actuator, a square shaft actuator, a bar operated plug valve or a plate manual wheel operator.

15. The device of claim 10, wherein geometric shape of the indicating means is substantially square, rectangular, circular, hexagonal, pentagonal, octagonal, triangular, heptagonal, nonagonal, or decagonal.

16. The device of claim 10, wherein the first and second side surfaces of the indicating means have a different color than the first and second end surfaces.

17. The device of claim 10, wherein the first or second side surface of the indicating means further comprises one or more of fluorescent coating, reflective coating, reflectors, distinctive color, or reflective means.

18. The device of claim 12, wherein the first or second side surface of the indicating means is visible in an open valve position and the first or second side surface is substantially less visible in a closed valve position.

19. An indicating means for providing a visual determination of an operational position of the valve comprising:
a first and a second substantially flat side surface;
a first and a second end surface substantially narrower that the first and the second side surface;
a top surface; and
a lower surface parallel to the top surface, adapted for engagement with an adapter means.

20. The indicating means of claim 19, wherein the lower surface comprises a groove, adapted for engagement with an upper surface of an adapter means.

21. The indicating means of claim 19, wherein geometric shape of the indicating means is substantially square, rectangular, circular, hexagonal, pentagonal, octagonal, triangular, heptagonal, nonagonal, or decagonal.

22. The indicating means of claim 19, wherein the first and second side surfaces have a different color than the first and second end surfaces.

23. The indicating means of claim 19, wherein the first or second side surface further comprises one or more of fluorescent coating, reflective coating, reflectors, distinctive color, or reflective means

24. An adapter comprising:
an upper surface adapted for engagement with an indicating means; and
a lower surface adapted for engagement with a specific valve or valve actuator design.

25. The adapter of claim 24, wherein the lower surface is adapted to accommodate engagement with a round shaft actuator, a square shaft actuator, a bar operated plug valve or a plate manual wheel operator.

26. The adapter of claim 25, wherein the upper surface of the adapter comprises a slot, the slot configured for engagement with a groove on an upper surface of an indicating means.

27. Use of the device of claim 1 for determining the operational position of a valve.

28. Use of the device of claim 10 for determining the operational position of a valve.
